(19) United States
(12) Patent Application Publication
(10) Pub. No.: US 2006/0118615 A1
(43) Pub. Date: Jun. 8, 2006

(54) System and method for secure transmission of electronic information

(76) Inventor: Giovanni Dominelli, Toronto (CA)

Correspondence Address: TORYS LLP, 79 WELLINGTON ST. WEST, SUITE 3000, TORONTO, ON, M5K 1N2, CA

(21) Appl. No.: 11/004,959

(22) Filed: Dec. 7, 2004

(51) Int. Cl. G06K 5/00

(52) U.S. Cl. 235/380

(57) ABSTRACT

The present invention provides a novel system and method for securely transmitting data. In an embodiment, the system is a merchant POS system that comprises a plurality of POS stations all of which are connected to a communications switch via a network. The POS stations each include a reader and a computing device joined by a link. The reader is operable to encrypt an identity of an account received from a financial card that is passed through the reader. The encrypted identity is then transmitted over the link, and decrypted by the computing device.

### FIELD OF THE INVENTION

The present invention relates to electronic information storage and transmission and more particularly to a system and method for secure transmission of electronic information.

### BACKGROUND OF THE INVENTION

Bank cards, debit cards, credit cards and the like (“cards”) can be based on a variety of technologies, including magnetic stripes, smart cards, radio-frequency identification (“RFID”). Cards have transformed the way both financial and other transactions are conducted. Such cards are an integral part of cashless transactions, in contrast to historic transactions that were completed through the use of checks or cash. Cards offer certain benefits over cash, in that they are often more convenient to use since they can eliminate the need to travel to banks for cash withdrawal, and are not negotiable per se, if stolen, the way cash is negotiable if stolen. Cards can also be preferred over checks since sellers can verify whether the buyer has sufficient resources to pay for the item, prior to the completion of the sale.

The prevalence of cards has been made possible by advances in computing and telecommunications. Magnetic stripe cards are frequently used with point of sale (“POS”) systems. An exemplary POS system includes a magnetic stripe card reader that connects to a local computer, which in turn connects to a remote server of a financial institution (or other remote processing center), which manages the debiting or crediting to the account. The card reader is able to read electronically stored information from the card. The electronically stored information typically contains identity information, such as an account number. When the card is swiped through the card reader, the identity information is passed to the local computer, which in turn passes the identity information to the financial institution server for processing.

However, POS systems of this type can carry some serious security concerns. Since it is relatively straightforward to create an illegal duplicate of a magnetic stripe card, constant attempts are made to intercept the identity information as it travels from the card reader to the remote server.

One common POS system frequently targeted for interception are those POS Systems that are incorporated into a standard personal computer. In this type of POS system, the card reader is connected to the local computer via a standard cable (e.g. PS/2) commonly used to connect pointing devices and keyboards to personal computers. In fact, such a card reader is typically integrated into a standard keyboard, and all data from the reader and keyboard are transmitted to the local computer in the usual manner. As a standard interface is employed as the conduit for the identity information, the identity information that is transmitted from the reader to the local computer is typically relatively easy to intercept. The interceptions are achieved using a Y-splitter to the card reader. One output of the Y-splitter feeds into the local computer in the usual manner. The second output of the Y-splitter is attached to a specialized storage device that captures the data sent on each card swipe as that data is transmitted to the local computer from the card reader.

The prior art proposes various ways to reduce the likelihood of interception of identity information in POS systems. One example is disclosed in U.S. Pat. No. 6,098,053, issued Aug. 1, 2000 entitled “System and method for performing an electronic financial transaction” to Slater. Slater discloses a system which consists of a local computer connected via the Internet to an Internet merchant's computer. The merchant's computer is connected to a financial institution's remote server through either the Internet or a direct connection. The identity information is entered at the local computer. After being encrypted at the local computer, the encrypted identity information is transmitted to the merchant's computer over the internet. The merchant's computer then transmits the encrypted data, along with additional information needed by a financial institution such as the price of the item to be purchased, to the remote server.

Slater has certain shortcomings. The point of sale envisaged by Slater is a new POS that is distinct from a merchant's POS which is located at a merchant's store. Slater states at column 6, line 47, “The rise in commerce being performed over public access networks with no direct connections to, or that are external from, the on-line ATM/POS system has created a new point-of-sale. One example of such a new point of sale is a personal computer connected to the Internet. These new points-of-sale, however, are outside of the current paradigm for connection to the on-line ATM/POS system. As a result, reliable and secure methods for performing an on-line ATM/POS transaction from these new POS sources are lacking. Therefore, the present invention beneficially allows a consumer the convenience of utilizing checking or savings account funds in an on-line ATM/POS transaction from a source that is remote from the on-line ATM/POS system, such as the Internet, thereby resulting in an external ATM/POS transaction that is on-line and in real time.” As such, Slater is not concerned with data interception at a POS but is concerned with interceptions that are likely to take place in the network, once the identity information leaves the local computer.

Another example is disclosed in U.S. Pat. No. 5,809,143, issued Sep. 15, 1998 entitled “Secure Keyboard” to Hughes. Hughes discloses a keyboard, which is attached, through a standard cable, to a local computer, which in turn is connected, through a communication network, to a remote server. The keyboard contains an encryption circuit. The keyboard also contains a modem which is directly connected to the remote server at the financial institution through a communication network. If the account number of the purchaser is entered at the keyboard, it is transmitted to the local computer through the standard cable. The local computer passes the data to the remote server through the communications network. However, when the personal identification (PIN) number associated with an information card is entered at the keyboard, such data is first encrypted by the encryption circuit, and then transmitted directly to the remote server through the built in modem located within the keyboard, bypassing the local computer.

The prior art disclosed by Hughes has certain problems. Hughes discloses a system that requires two modems, one to be located in the local computer and the other in the keyboard itself. Each of these modems are in need of a separate connection for communicating with the remote server. Hence, the system disclosed by Hughes duplicates hardware and connections, increasing the complexity and difficulty of the system, and its setup.

Another example of a known solution is disclosed in U.S. Pat. No. 5,517,569, issued May 14, 1996 entitled “Methods and Apparatus for Interfacing an Encryption module with a personal computer” to Clark. Clark discloses a system consisting of a card reader, containing an encryption circuit. The card reader connects to a local computer through a standard cable. The local computer is connected to a remote server through a modem. After the information contained in an information card is acquired by the card reader, the information is encrypted by the encryption circuit located within the reader, and is transmitted to the local computer through the standard cable. The local computer then transmits the encrypted data to the remote server through the modem.

The system disclosed by Clark has certain limitations. Clark aims to reduce the likelihood of interception that occurs within the local computer. Moreover, interceptions envisaged by Clark are of the type that are carried out by software such as Trojan horse and worm programs. Clark states at column 1, line 65 “ . . . presently known systems generally require that the confidential data (e.g. PIN) be entered into the computer via the keyboard associated with the PC, whereupon the PC's processor controls the encryption process. Thus, the data is essentially transmitted from the keyboard to the PC mother board over the physical wires connecting the keyboard to the PC box. Thereafter, the unencrypted data, i.e., prior to completing the encrypting process, necessarily resides on the mother board, for example prior to and during the encryption process. It is believed that sophisticated electronic “listening” devices could thus be employed to detect the confidential data between the time it is entered into the keyboard by the user and the time at which encryption is complete.”

Systems disclosed by the prior art send to the remote server some or most of the information read from an information card in an encrypted format. In order for the prior art, which sends identity information in an encrypted format, to be used with the currently existing information card processing systems, remote servers need to have decryption facilities to complement the encryption performed at the reader or at the local computer. In large organizations where a legacy set of servers are used, the overhaul of such servers to include complementary decryption facilities can be onerous and complex task. Also, assuming such an overhaul is performed, update and maintenance of the system continues to be somewhat complicated. For example, in order to update encryption keys, all the local encryption devices and the remote servers would require updating. This, in turn, may require coordination not only amongst the owners of different local computers, but also between different institutions that operate remote servers which handle different types of information cards. Therefore, it is desirable to provide another means to address the problem of intercepting identity information carried from a card reader to a local computer via a standard interface.

### SUMMARY OF THE INVENTION

It is an object of the present invention to provide a novel system and method for secure transmission of electronic information that obviates or mitigates at least one of the above-identified disadvantages of the prior art.

According to an aspect of the invention, a point of sale station for obtaining an identity of an account stored on a financial card is provided. The station comprises a reader for receiving the identity from the card in a first format. The station also comprises an encryption device local to the reader for converting the identity to an encrypted format. The station further comprises a computing device which has a decryption device for converting the identity back to the first format. The station also comprises a link which interconnects the encoding device and the computing device, and is used for transmitting the identity in the encrypted format to the computing device.

The financial card can be a magnetic stripe card and the reader can be a magnetic stripe reader. The first format can be the ISO 7811-2 Magnetic Standards format. The decryption device can be operable to convert the identity from the encrypted format to a third format that is different from the first format. The third format can correspond to a format of the account accepted by a financial institution server that is connected to the computing device.

The financial card can be selected from the group consisting of a debit card and a credit card. The link can be a PS/2 cable. The reader can be integral with a keyboard or with a point-of-sale PIN pad such as a Hypercom S9 PIN Pad.

Another aspect of the invention provides a method for securely transmitting identity of an account between an account storage medium and a computing device comprising the steps of:
receiving the identity from an account storage medium in a first format;
converting the identity to a second format; and
transmitting the identity in the second format to the computing device which is operable to convert the identity back to the first format, such that an eavesdropping device cannot recover the identity in the first format during the transmitting step.

The method can further comprise the steps of receiving the identity in the second format at the computing device and converting, at the computing device, the identity back to the first format. The account storage medium used in the method can be a financial card having a magnetic stripe. The first format used in the method can be the ISO 7811-2 Magnetic Standards format.

The method can further comprise the steps of receiving the identity in the second format at the computing device and converting, at the computing device, the identity into a third format which corresponds to a format of the account accepted by a financial institution server that is connected to the computing device. The financial card used in the method can be selected from the group consisting of a debit card and a credit card.

Another aspect of the invention provides a point of sale input device comprising a reader for receiving an identity of an account stored on a financial card in a first format. The input device also comprises an encryption device local to the reader for converting the identity to an encrypted format. The input device further comprises an output port connected to the encryption device for connection to a computing device via a link. The computing device includes a decryption device for converting the identity back to the first format such that an eavesdropping device cannot recover the identity in the first format during transmission of the identity in the second format over the link.

Another aspect of the invention provides a computing device for obtaining an identity of an account comprising an input port for receiving the identity in a first format. The identity is converted into the first format by a reader connected to the input port via a link. The reader is operable to receive the identity in a second format and convert the identity into the first format prior to transmission over the link. The computing device also comprises a decryption device for converting the identity back to the second format from the first format.

### BRIEF DESCRIPTION OF THE DRAWINGS

The invention will now be described by way of example only, and with reference to the accompanying drawings, in which:

FIG. 1 is a schematic representation of a system for secure transmission of electronic information in accordance with an embodiment of the invention;

FIG. 2 is a block-diagram representation of an input device in accordance with an embodiment of the invention;

FIG. 3 is a block-diagram representation of a local computing device;

FIG. 4 shows a flow-chart depicting a method for processing requests in accordance with another embodiment of the invention;

FIG. 5 shows the system of FIG. 1 during the performance of certain steps of method 200;

FIG. 6 shows the system of FIG. 1 during the performance of certain steps of method 200;

FIG. 7 shows the system of FIG. 1 during the performance of certain steps of method 200;

FIG. 8 shows the system of FIG. 1 during the performance of certain steps of method 200;

FIG. 9 shows the system of FIG. 1 during the performance of certain steps of method 200;

FIG. 10 shows the system of FIG. 1 during the performance of certain steps of method 200;

FIG. 11 shows a flow-chart depicting a method for processing certain steps of method 200 in accordance with another embodiment of the invention;

FIG. 12 shows the system of FIG. 1 during the performance of certain steps of method 200₁;

FIG. 13 shows the system of FIG. 1 during the performance of certain steps of method 200₁;

FIG. 14 shows the system of FIG. 1 during the performance of certain steps of method 200₁;

FIG. 15 shows the system of FIG. 1 during the performance of certain steps of method 200₁;

FIG. 16 shows the system of FIG. 1 during the performance of certain steps of method 200₁; and

FIG. 17 shows the system of FIG. 1 during the performance of certain steps of method 200₁.

### DETAILED DESCRIPTION OF THE INVENTION

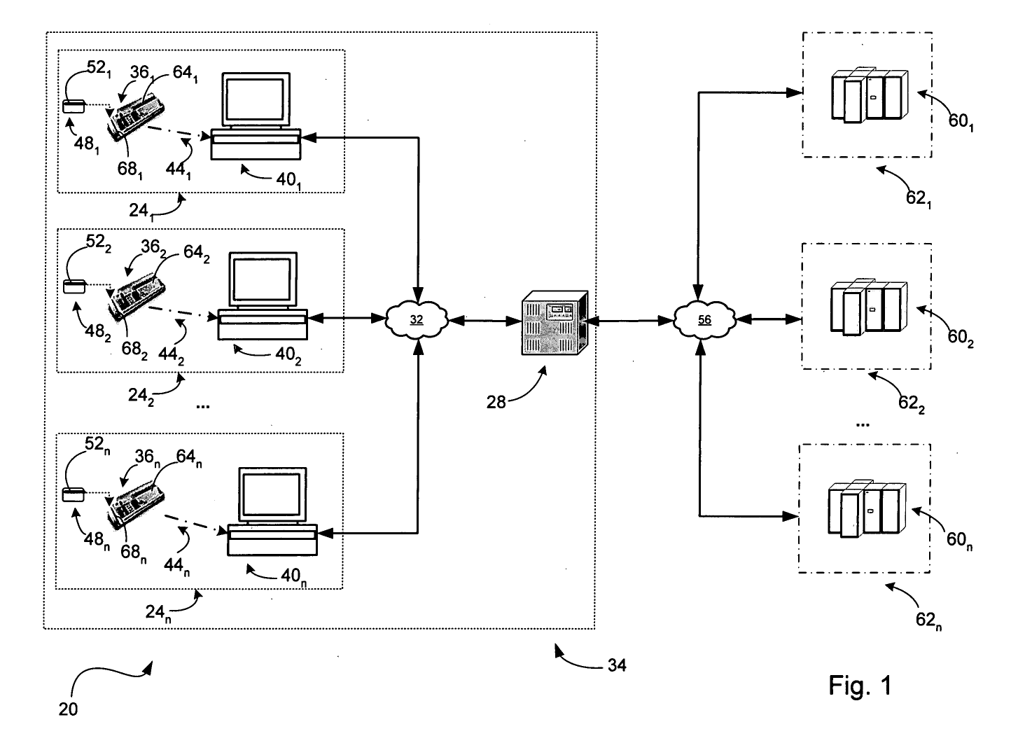

Referring now to FIG. 1, a system for securely transmitting data is indicated generally at 20. In a present embodiment system 20 is a merchant POS system. POS system 20 comprises a plurality of POS stations 24₁, 24₂ . . . 24ₙ. (generically referred to herein as “station 24”) all of which are connected to a communications switch 28 via a network 32. In a present embodiment, station 24 and switch 28 are proprietary to a single merchant 34. Switch 28 connects, via network 56, to a plurality of remote servers 60₁, 60₂ . . . 60ₙ, (generically referred to herein as “remote server 60”) all of which are respective to different financial institutions 62₁, 62₂ . . . 62ₙ (generically referred to herein as “financial institution 62”).

Each station 24 comprises an input device 36 that is connected to a local computing device 40 via a standard cable 44. In a present embodiment input device 36 is a combination of a keyboard 64 and a magnetic stripe card reader 68. Keyboard 64 is a standard QWERTY keyboard, but other keyboard layouts are within the scope of the invention. Reader 68 of input device 36 is operable to read data from an information card 48, which in a present embodiment is a standard plastic card that includes a magnetic stripe 52 which stores the data according to known standards.

As an example of how data can be stored on card 48, such data begins in the ASCII-1967 format as published by the Commité Consultatif International Telegraphique et Telephonique (CCITT) standards organization (ASCII format), or any other suitable format. The ASCII formatted data is then stored on stripe 52 in the ISO 7811-2 Magnetic Standards format (ISO magnetic format) although other magnetic formats whether standard or proprietary are within the scope of the invention. When card 48 is swiped through reader 68 the ISO formatted data is returned to ASCII format by reader 68.

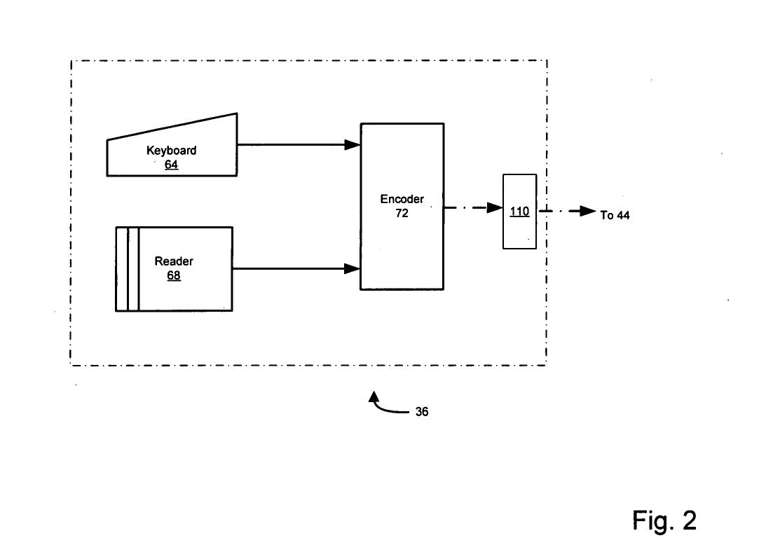

Input device 36 is shown in greater detail in FIG. 2 in a block-diagram format. As seen in FIG. 2, keyboard 64 and reader 68 each deliver their output to an encoder 72. As mentioned, reader 68 is operable to receive data stored in ISO magnetic format on stripe 52 when card 48 is passed through reader 68, and convert that data into ASCII format. Reader 68 is also operable to pass the data in ASCII format to encoder 72. Encoder 72 is operable to convert the ASCII formatted data into an encoded format before passing the encoded data to an output port 110. Encoder 72 is also operable to pass through any data that does not need to be encoded, and transmit such data to output port 110. Output port 110 is attached to standard cable 44 (either hardwired or via a removable connector) and is operable to transmit the data to standard cable 44 for transmission to device 40.

In a present embodiment local computing device 40 is based on the computing environment of a standard personal computer such as a Dell Dimension 2400 with an Intel Celeron Processor, 256 MB DDR-SDRAM memory, and a 40 gigabyte Ultra ATA/100 Hard Drive manufactured by Dell Inc., One Dell Way, Round Rock, Tex. 78682, United States. However, it is to be emphasized that this particular computing device is merely exemplary, and a vast array of other types of computing environments for local computing device 40 are within the scope of the invention.

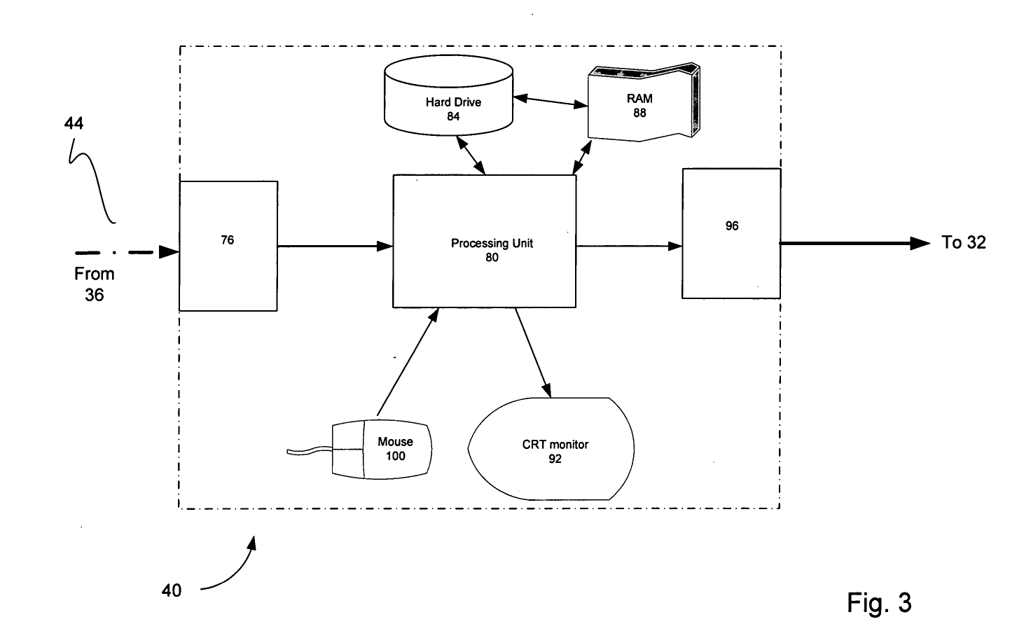

Local computing device 40 is shown in greater detail in FIG. 3 in a block-diagram format. As seen in FIG. 3, local computing device 60 houses an input port 76 that is connected to standard cable 44 and receives data transmitted over cable 44. In a present embodiment, output port A, cable 44 and input port 76 conform substantially to the PS/2 keyboard interface standard originally promulgated by International Business Machines (IBM) of Armonk N.Y. In this embodiment, cable 44 is a standard PS/2 cable that terminates with a 6-pin mini-DIN male connector. By the same token, input port 76 is a bidirectional synchronous serial port that communicates through a female 6-pin mini-DIN female connector to which the male connector of cable 44 can be attached. Output port 110 is operable to transmit data, via cable 44, to input port 76 and input port 76 is operable to receive data from output port 110 via cable 44 using bidirectional synchronous serial protocol according to the PS/2 standard. However, it is to be emphasized that this particular interface is merely exemplary, and other types of interfaces for connecting input devices to computing devices, such as the Universal Serial Bus (USB) as specified by the USB Implementers Forum are within the scope of the invention.

Input port 76 is further operable to deliver data that is received from cable 44 to a processing unit 80. Processing unit 80 interconnects a persistent storage unit 84 (such as a hard disk drive) and a volatile storage unit 88 (such as random access memory (RAM)). Processing unit 80 is also connected to a display 92 (such as a CRT or an LED monitor) in order to present user output thereon. Processing unit 80 is also connected to a network port 96, for delivering output from local computing device 40 to network 32. Local computing device 40 is also operable to receive input from an operator through a pointing device 100 such as a standard computer mouse, and present information to the operator on display device 92.

As will be explained in greater detail below, input port 76 is operable to receive data in the encoded format sent from input device 24 through standard cable 44 and pass the encoded data on to processing unit 80. Processing unit 80 is operable to convert the data from the encoded format into ASCII format by utilizing a set of instructions stored in storage unit 84. Processing unit 80 is further operable to transmit the converted data, in ASCII format, to switch 28 located at a remote location via network port 96. Processing unit 80 is also operable to receive responses from switch 28, via network 32.

Referring again to FIG. 1, switch 28 is a server, router, or other type of computing environment that is operable to receive data from and send data to local computing device 40. Switch 28, is further operable to transmit the data received in ASCII format from local computing device 40 to an appropriate remote server 60 located at a respective financial institution 62 via network 56. The data obtained from local computing device 40 is used to access information at remote server 60 in the usual manner. Likewise, the information thus accessed is relayed back to the local computing device 40 so the financial transaction can proceed in the usual manner. Switch 28 can be based on any type computing environment for switch 28 are within the scope of the invention, as will occur to those of skill in the art.

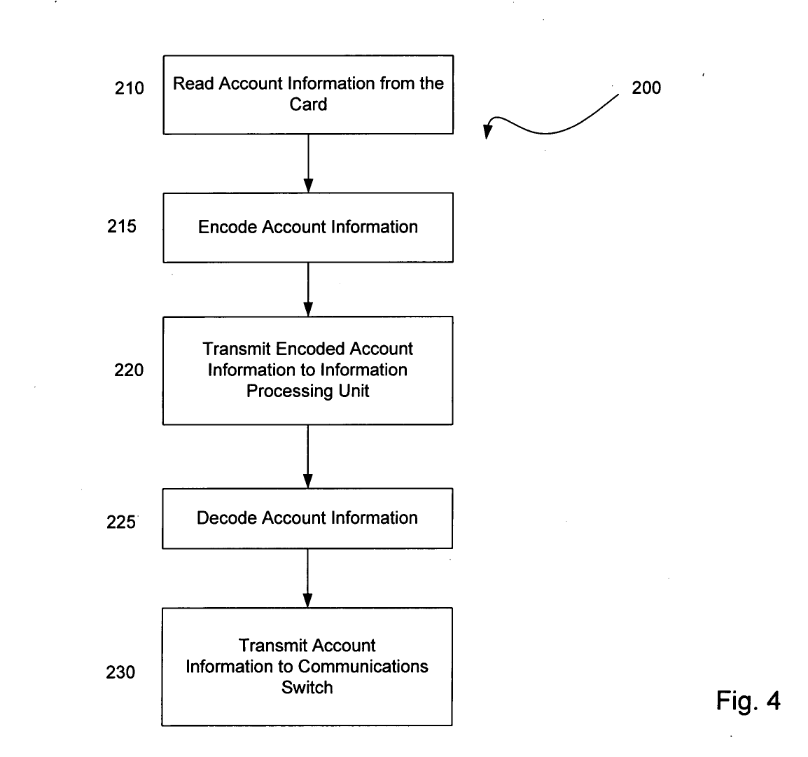

Referring now to FIG. 4, a method for processing a credit card transaction in accordance with another embodiment of the invention is indicated generally at 200. In order to assist in the explanation of the method, it will be assumed that method 200 is operated using system 20. Furthermore, the following discussion of method 200 will lead to further understanding of system 20 and its various components. However, it is to be understood that system 20 and/or method 200 can be varied, and need not work exactly as discussed herein in conjunction with each other, and that such variations are within the scope of the present invention.

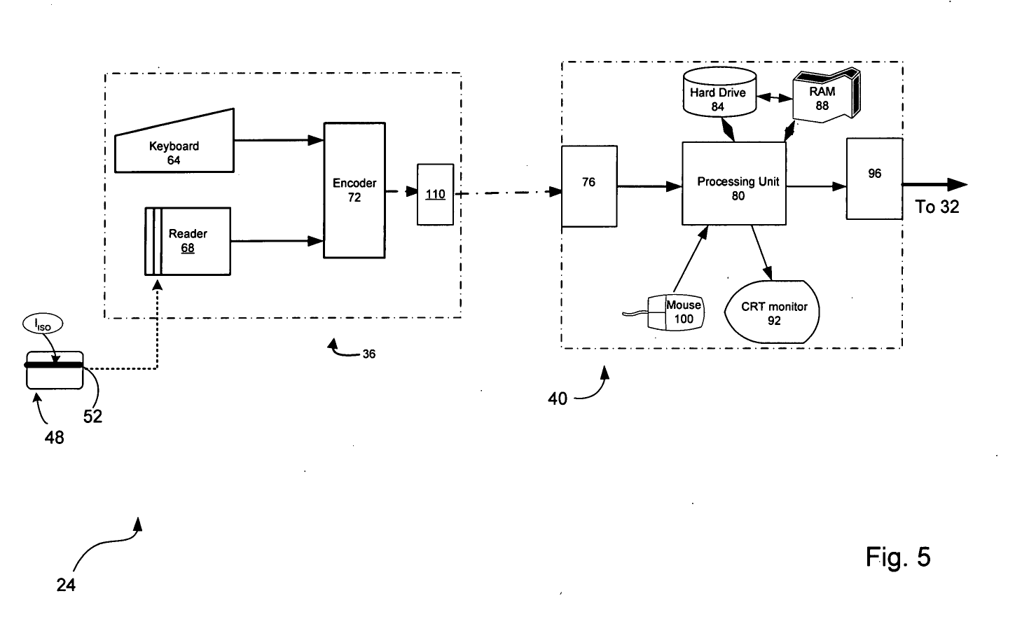

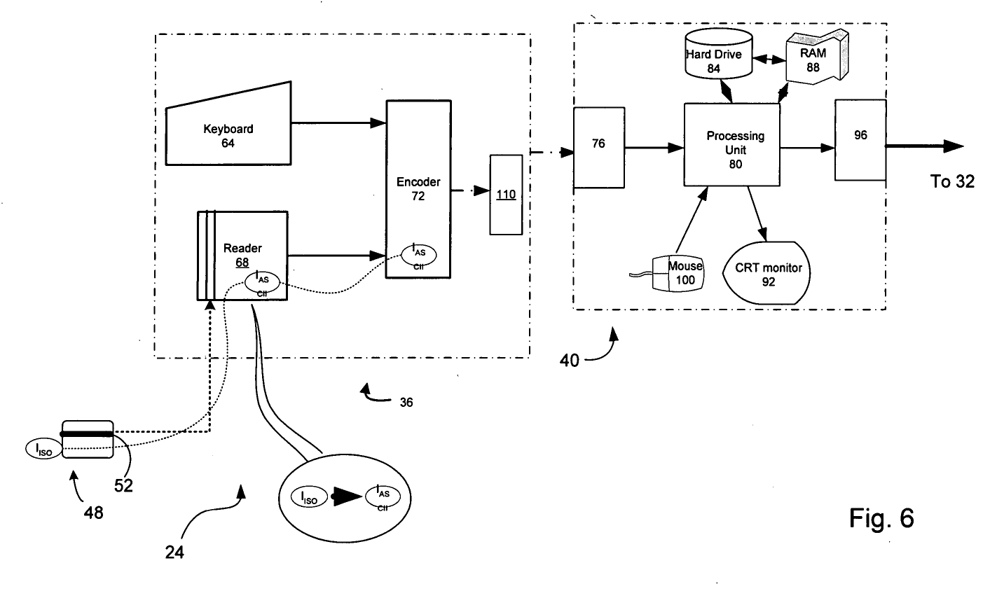

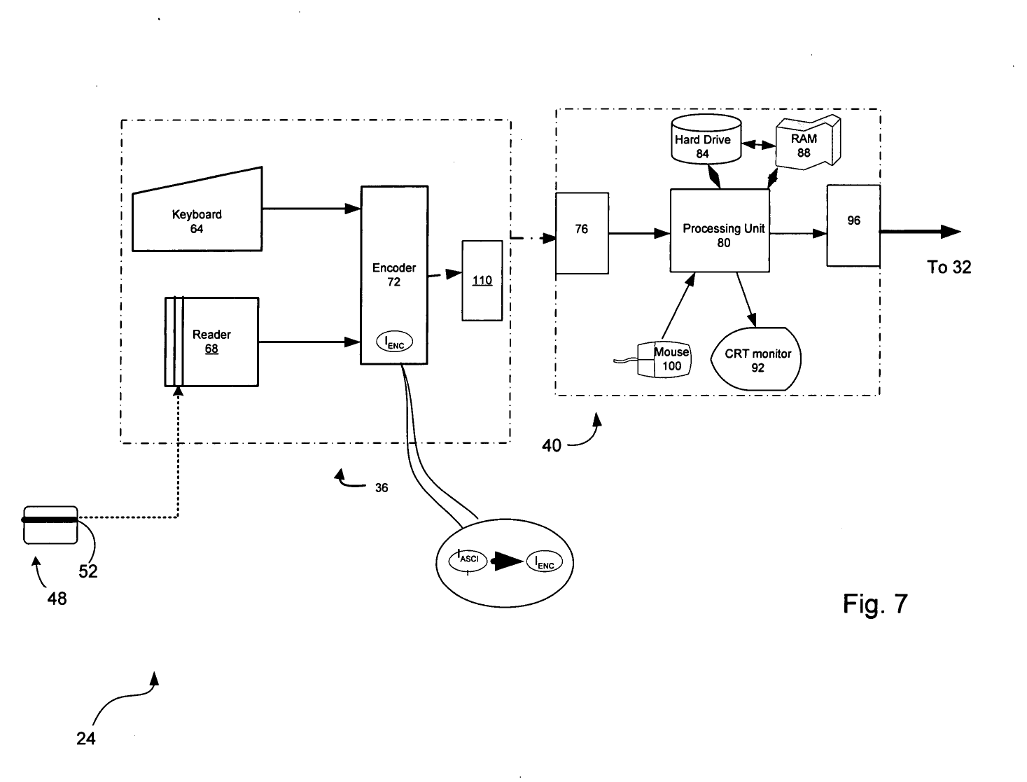

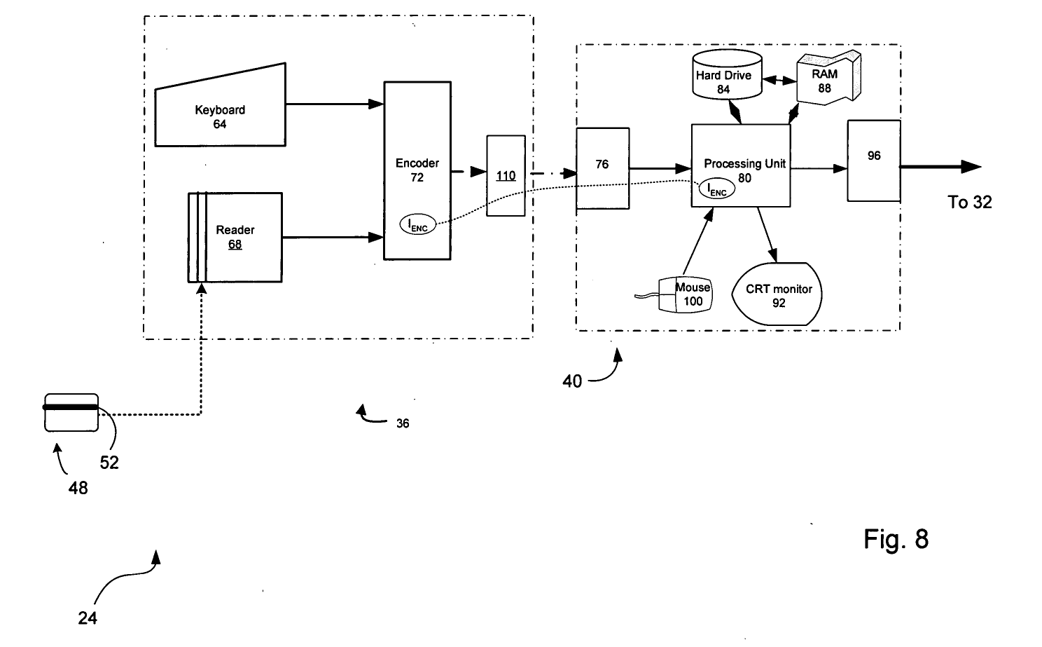

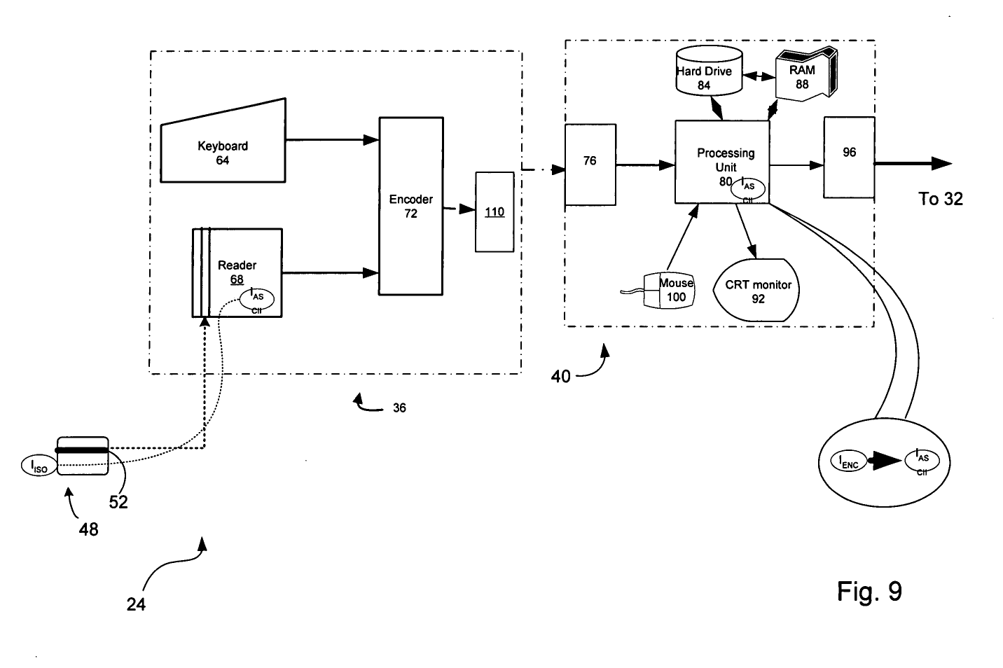

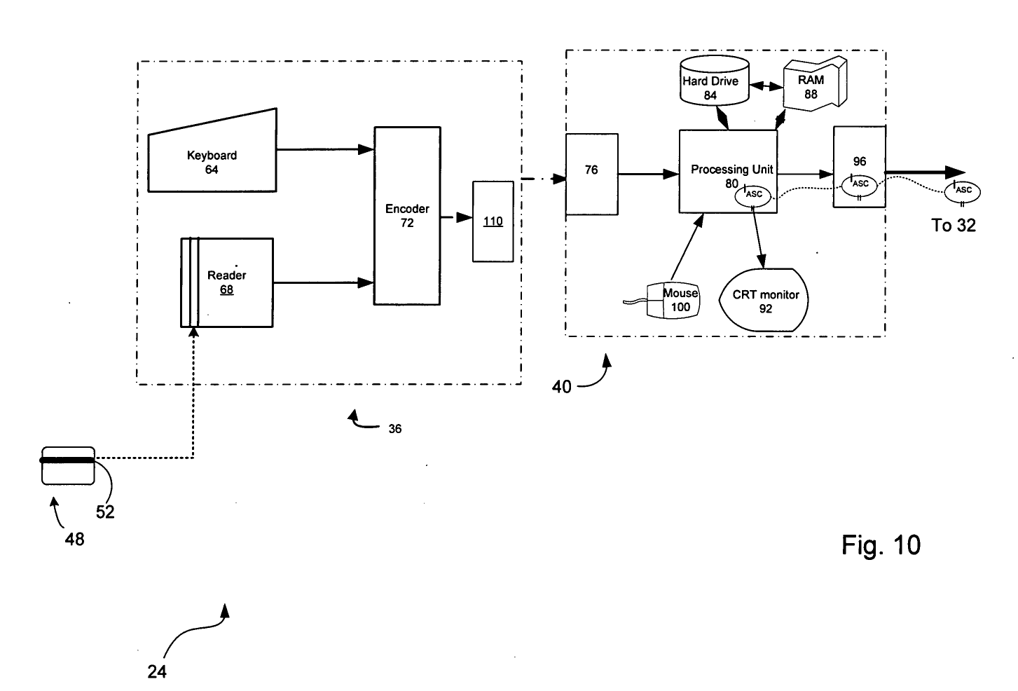

Having introduced method 200, reference will now be made to FIG. 5 to illustrate the method of operation. In order to assist in the explanation, it will be assumed that the magnetic card is a credit card, and that the data stored on the card is account information. It will be further assumed that the account information contained on the credit card was in the ASCII format prior to being stored on the card in the ISO magnetic format such account information being indicated in FIG. 5 as an oval with the reference I_{ISO}. Beginning first at step 210, card 48 is swiped at card reader 68 by sliding stripe 52 through a slot in reader 68. As shown in FIG. 6, the swiping motion causes reader 68 to read the account information I_{ISO} stored on stripe 52 in ISO magnetic format and convert it to ASCII format. The ASCII formatted account information I_{ASCII} is now made available to encoder 72. Moving to step 215, and shown in FIG. 7, encoder 72 encodes the account information I_{ASCII} into an encoded format, represented in FIG. 7 as encoded account information I_{ENC}. Next, at step 220 encoder 72 transmits the encoded account information I_{ENC} to output port A, as illustrated in FIG. 8. The encoded account information I_{ENC} is then passed onto input port 76 via cable 44 using a bidirectional synchronous serial protocol according to the PS/2 standard. Input port 76, in turn, sends the encoded account information I_{ENC} to processing unit 80. Then, at step 225, as shown in FIG. 9, processing unit 80 decodes the encoded account information I_{ENC} back into ASCII format by utilizing a set of instructions stored in storage unit 84 thereby recovering account information I_{ASCII}. Following the decoding, at step 230 as illustrated in FIG. 10, processing unit 80 sends the account information I_{ASCII} to network port 96. Finally, once the account information I_{ASCII} is received at port 96, it is sent out from POS station 24, in ASCII format, for completion of the transaction in the usual manner.

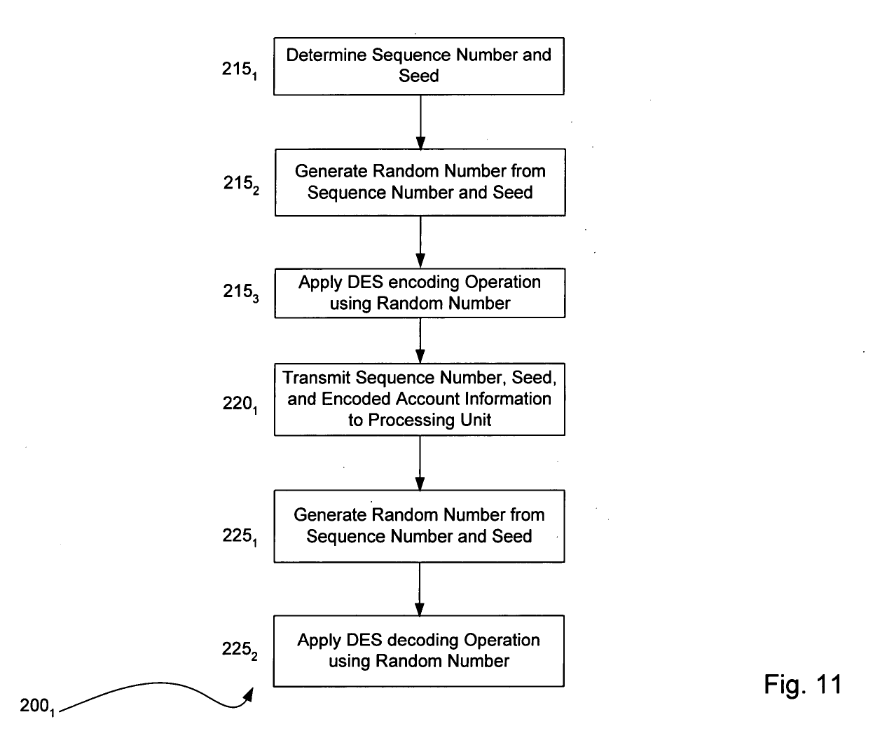

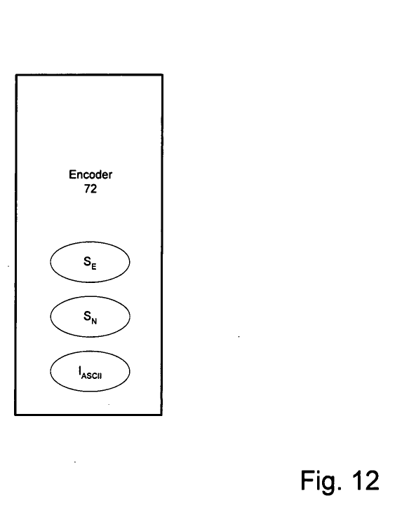

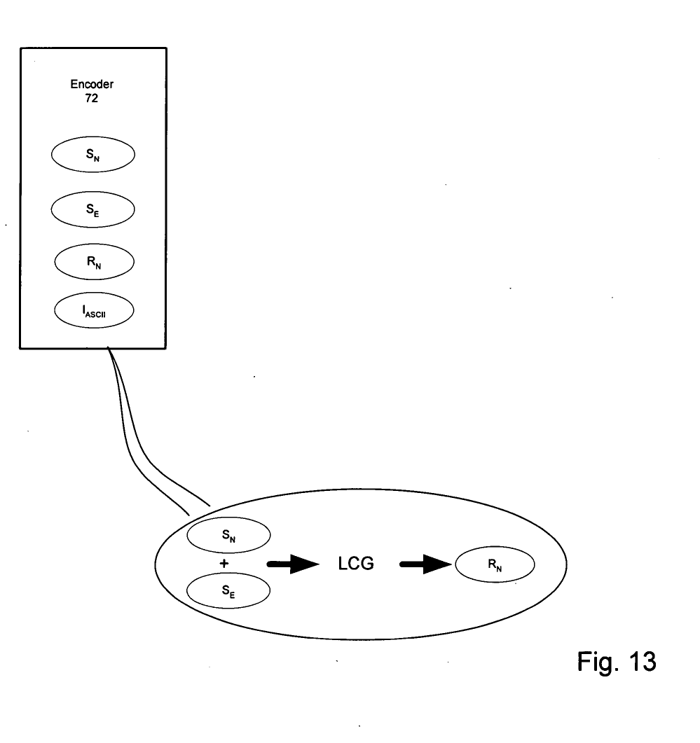

It is to be understood that the various steps in method 200 can be performed in a number of ways. For example, steps 215 through 225 of method 200 can be performed using the sub-steps shown at method 200₁ in FIG. 11. Starting at step 215₁, as shown in FIG. 12, encoder 72 first picks a sequence number S_{N}, and a seed S_{E}. Sequence number S_{N} and a seed S_{E} can be initially chosen using any random number generation operation that will occur to those of skill in the art. Encoder 72 then generates, at step 215₂, as illustrated in FIG. 13, a random number R_{N} using the sequence number S_{N}, seed S_{E} and a linear congruential generator (LCG) as described in “Mathematical methods in large-scale computing units,” in Proc. 2nd Sympos. on Large-Scale Digital Calculating Machinery, Cambridge, Mass., 1949, pages 141-146, Cambridge, Mass., 1951, Harvard University Press, the contents of which are incorporated herein by reference. However, it is to be emphasized that this particular random number generator operation is merely exemplary, and a vast array of other types of random number generator operations are within the scope of the invention.

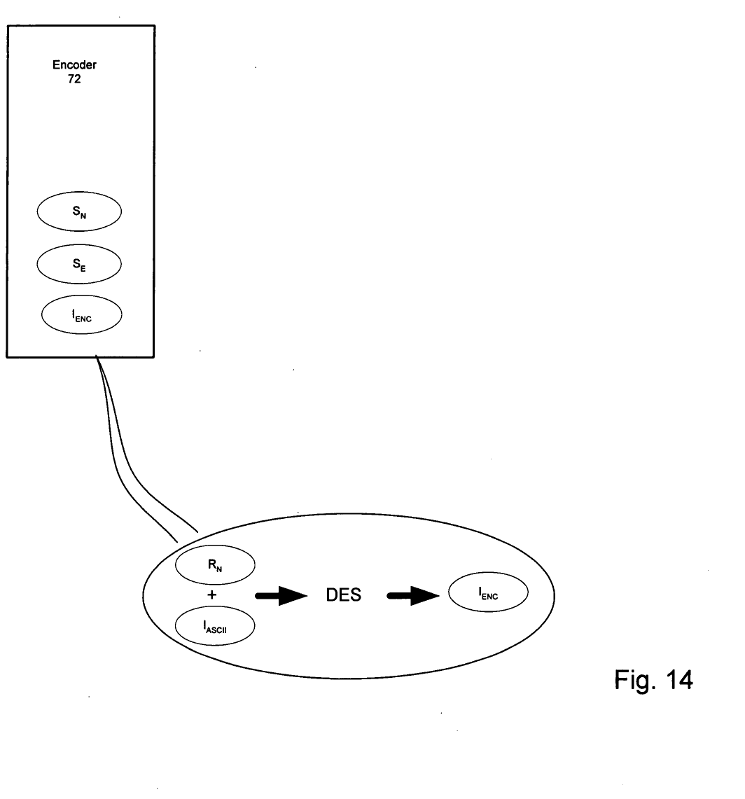

Continuing with the example, LCG is a recursive operation of the type:
Rₓ₊₁=23Rₓ+0 mod (10⁸+1)

where the seed S_{E} is used as the initial input R₀, and sequence number S_{N} defines the number of iterations to take in order to generate the random number R_{N} (i.e. R_{N}=R_{Sn}). Next, at step 215₃, as shown in FIG. 14, with the aid of the random number R_{N} encoder 72 encodes the account information I_{ASCII} into the encoded format I_{ENC} by applying the data encryption standard (DES) operation as described in Federal Information Processing Standards publication FIPS PUB 46-2, published on 1988 Jan. 22. However, it is to be emphasized that this particular encoding operation is merely exemplary, and various other types of encoding operations are within the scope of the invention.

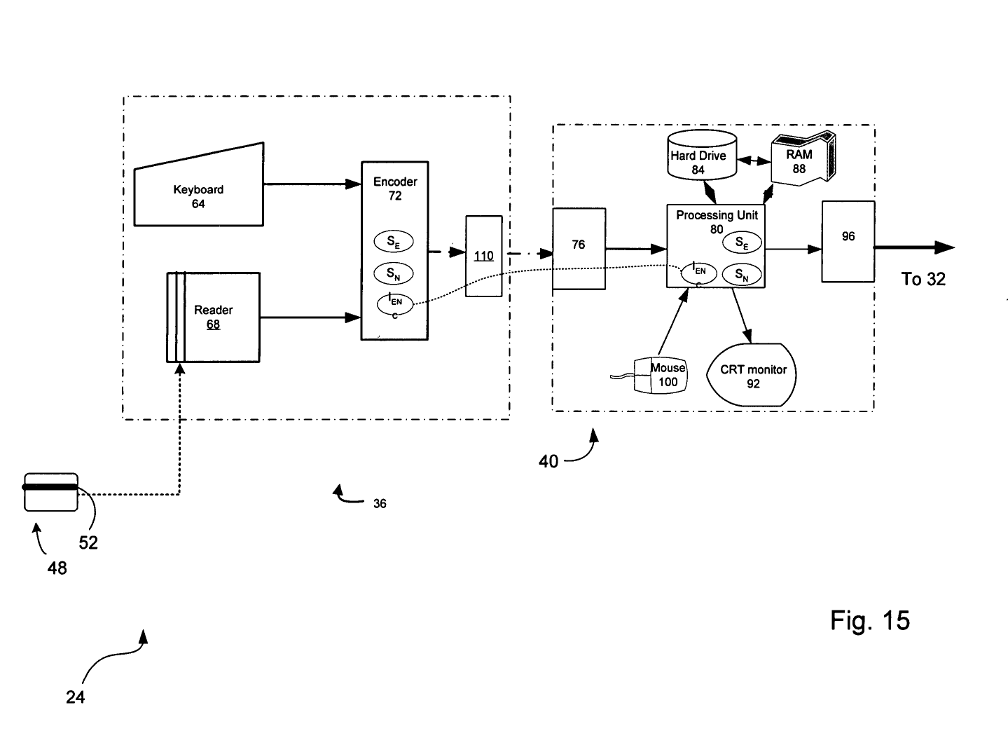

Moving to step 220₁, as shown in FIG. 15, encoder 72 transmits the encoded account information I_{ENC} as well as sequence number S_{N} and seed S_{E} to output port A. The encoded account information I_{ENC}, sequence number S_{N} and seed S_{E} are then passed onto input port 76 via cable 44 using a bidirectional synchronous serial protocol according to the PS/2 standard. Input port 76, in turn, sends the account information to processing unit 80.

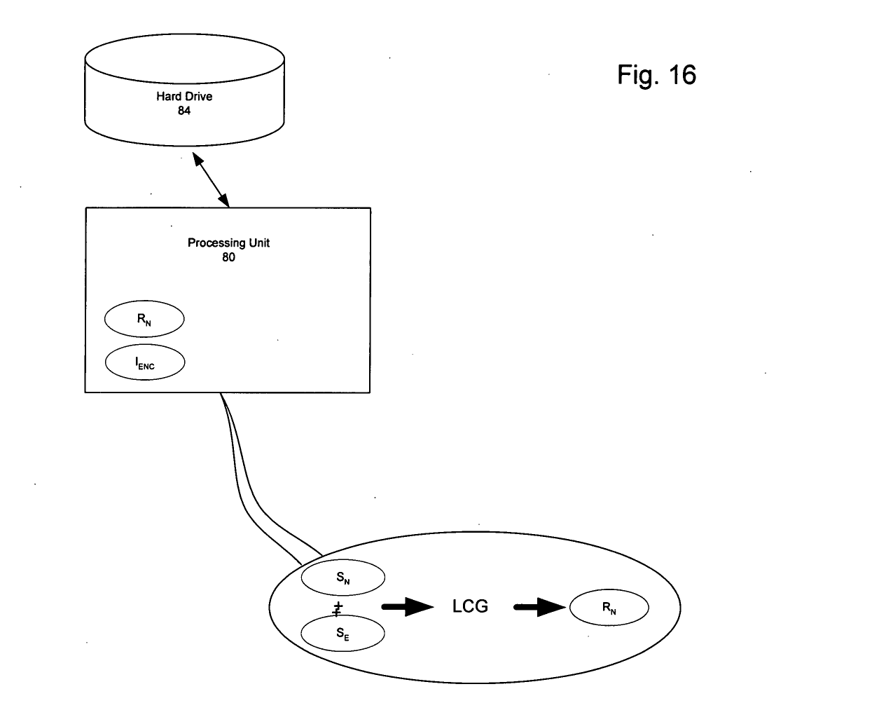

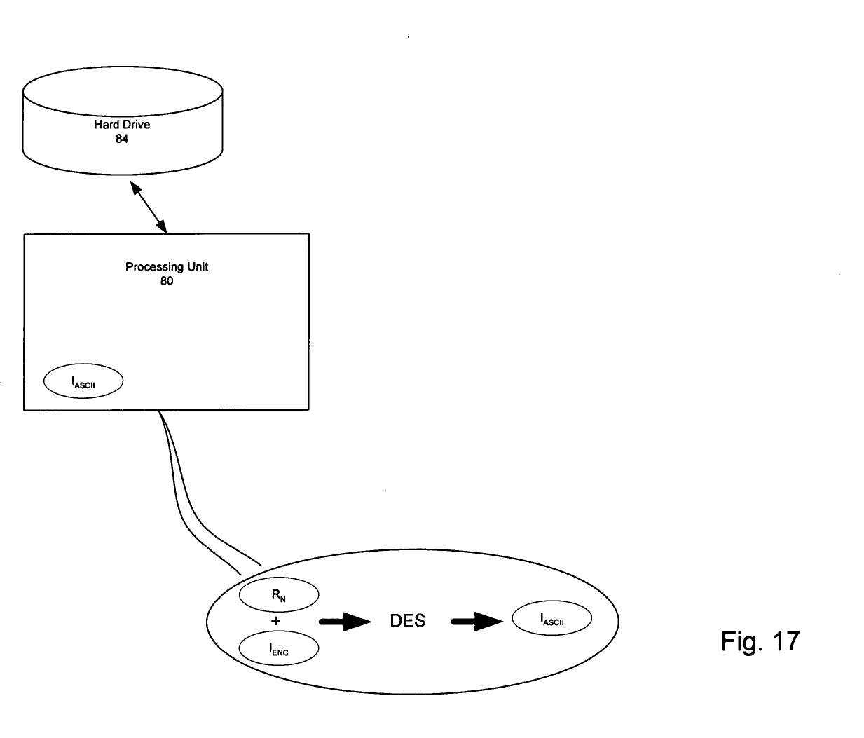

Then, at step 225₁, illustrated in FIG. 16, processing unit 80 uses a set of instructions stored in storage unit 84 implementing an LCG identical to the one used at step 215₂ to generate the same random number R_{N} generated at step 215₂. Next, at step 225₂, as illustrated in FIG. 17, with the aid of the random number R_{N} generated at step 225₂, processing unit 80 decodes the account information I_{ENC} into ASCII format by utilizing a set of instructions stored in storage unit 84 implementing the DES operation thereby recovering account information I_{ASCII}.

While only specific combinations of the various features and components of the present invention have been discussed herein, it will be apparent to those of skill in the art that desired subsets of the disclosed features and components and/or alternative combinations of these features and components can be utilized, as desired. For example, the teachings herein can be applied to other types of information cards, in addition to bank cards, debit cards and credit cards. Examples of such other types of information cards include health cards, national ID cards, drivers licenses and student cards, amongst others.

In a present embodiment switch 28 is a legacy device operated by the same merchant that operates local stations 24. However, it is to be emphasized that this particular operation arrangement is merely exemplary. In other embodiments, it is possible to assign the operation of local stations 24 and switch 28 to different entities. In yet other embodiments, local stations 24 can each be operated by different entities. At this point it should now be apparent to a person skilled in the art that there are an unlimited number of permutations of assignments to different entities of the operation of local stations 24 and switch 28.

The present invention provides a novel system and method for secure transmission of electronic information. Embodiments if the invention can provide certain advantages over the prior art, particularly in an environment where merchant 34 is based on a legacy infrastructure of computing devices 40 and switch 28, and where switch 28 is operable to communicate with each of computing devices 40 employing legacy hand-shaking and communication protocols known to both switch 28 and devices 40. The teachings herein can be applied to such legacy infrastructures, without the need to conduct complex modifications to switch 28, or link 32, yet still providing a certain level additional security over link 44.

The above-described embodiments of the invention are intended to be examples of the present invention and alterations and modifications may be effected thereto, by those of skill in the art, without departing from the scope of the invention which is defined solely by the claims appended hereto.

1. A point of sale station for obtaining an identity of an account stored on a financial card, said system comprising:
a reader for receiving said identity from said card in a first format;
an encryption device local to said reader for converting said identity to an encrypted format;
a computing device for receiving said identity in said encrypted format and further having a decryption device for converting said identity back to said first format; and,
a link interconnecting said encoding device and said computing device for transmitting said identity in said encrypted format.

2. The station of claim 1 wherein said financial card is a magnetic stripe card and said reader is a magnetic stripe reader.

3. The station of claim 2 wherein said first format is the ISO 7811-2 Magnetic Standards format.

4. The station of claim 1 wherein said decryption device is operable to convert said identity from said encrypted format to a third format that is different than said first format, said third format corresponding to a format of said account accepted by a financial institution server that is connected to said computing device.

5. The station of claim 1 wherein said financial card is selected from the group consisting of a debit card and a credit card.

6. The station of claim 1 wherein said link is selected from the group consisting of a PS/2 cable and a USB cable.

7. The station of claim 1 wherein said reader is integral with a keyboard.

8. The station of claim 1 wherein said reader is integral with a point-of-sale PIN-pad.

9. A method for securely transmitting identity of an account between an account storage medium and a computing device comprising the steps of:
receiving said identity from an account storage medium in a first format;
converting said identity to a second format; and,
transmitting said identity in said second format to said computing device operable to convert said identity back to said first format, such that an eavesdropping device cannot recover said identity in said first format during said transmitting step.

10. The method of claim 9 further comprising the steps of receiving said identity in said second format at said computing device and converting, at said computing device, said identity back to said first format.

11. The method of claim 9 wherein said account storage medium is a financial card having a magnetic stripe.

12. The method of claim 11 wherein said first format is the ISO 7811-2 Magnetic Standards format.

13. The method of claim 9 further comprising the steps of receiving said identity in said second format at said computing device and converting, at said computing device, said identity into a third format, said third format corresponding to a format of said account accepted by a financial institution server that is connected to said computing device.

14. The method of claim 11 wherein said financial card is selected from the group consisting of a debit card and a credit card.

15. A point of sale input device comprising:
a reader for receiving an identity of an account stored on a financial card in a first format;
an encryption device local to said reader for converting said identity to an encrypted format; and,
an output port connected to said encryption device and for connection to a computing device via a link; said computing device including a decryption device for converting said identity back to said first format such that an eavesdropping device cannot recover said identity in said first format during transmission of said identity in said second format over said link.

16. A computing device for obtaining an identity of an account comprising:
an input port for receiving said identity in a first format; said identity having been converted into said first format by a reader connected to said input port via a link; said reader operable to receive said identity in a second format and convert said identity into said first format prior to transmission over said link; and,
a decryption device for converting said identity back to said second format from said first format.
